(19) United States
(12) Patent Application Publication
(10) Pub. No.: US 2002/0169838 A1
(43) Pub. Date: Nov. 14, 2002

(54) E-mail address change notification deputization system and e-mail address change notification deputization method

(76) Inventor: Tetsuo Oyama, Osaka (JP)

Correspondence Address: RATNER AND PRESTIA, Suite 301, One Westlakes, Berwyn, P.O. Box 980, Valley Forge, PA, 19482-0980, US

(21) Appl. No.: 10/025,805

(22) Filed: Dec. 18, 2001

(30) Foreign Application Priority Data
Dec. 18, 2000 (JP) 2000-384,432

(51) Int. Cl. G06F 15/16

(52) U.S. Cl. 709/206

(57) ABSTRACT

An e-mail address change notification deputization system has a first provider server in which a first e-mail address of a client is set;

a second provider server in which a second e-mail address of the client is set; and

an address change notification deputization service server,

wherein the first provider server transfers an e-mail that is sent to the first mail address to the second provider server upon receiving this e-mail,

wherein the second provider server transfers an e-mail that has been transferred from the first provider server to the address change notification deputization service server upon receiving this e-mail, and

wherein the address change notification deputization service server checks the path of the e-mail that has been transferred from the second provider server and makes a notification to the sender of the e-mail to the effect that the e-mail address of the client is the second mail address in the case that this e-mail is received by the second provider server after transfered by the second provider server.

### BACKGROUND OF THE INVENTION

1. Field of the Invention

The present invention relates to an e-mail address change deputization system, an e-mail address change deputization method, and the like, on a network used at the time when the user changes providers, or the like.

2. Related Art of the Invention

In recent years, due to the remarkable spread in the use of personal computers and the Internet, most people have an e-mail address so as to gain the benefit of easy communication using e-mail.

As for the easiest means for a general user to receive a service over a network such as electronic mail, and the like, by having a connection to the Internet, the user makes a contract with a provider, which is a private company, so as to get an account for network utilization or to get an electronic mail address (hereinafter referred to as an e-mail address) issued so that the user can receive an e-mail from another user by using the above e-mail address as the user's address or the user utilizes the above e-mail address as the destination of a reply e-mail in the case that the user transmits an e-mail to another user.

In recent years, however, a great variety of providers have come into existence and, therefore, it is no longer unusual for the user to change providers in order to gain merits such as better service or lower fees according to differences in connection fees or types of services.

The user must change e-mail addresses at the same time that the provider is changed and it is necessary to inform the user's contacts, with which the user has been in communication using the e-mail address given by the provider before the change, of the change in e-mail addresses.

There is a problem that the notification of such a change becomes more bothersome the higher the frequency of change in providers becomes.

### SUMMARY OF THE INVENTION

The present invention is provided in accordance with a review of the above described problem and an object of the invention is to provide an e-mail address change notification deputization system, e-mail address change notification deputization method, and the like, wherein it is possible to carry out an e-mail address change notification deputization service by which a notification that e-mail address is changed is made in place of the user according to the change in providers.

The 1st invention of the present invention is an e-mail address change notification deputization system comprising:

a first provider server in which a first e-mail address of a client is set;

a second provider server in which a second e-mail address of said client is set; and

an address change notification deputization service server,

wherein said first provider server transfers an e-mail that is sent to said first mail address to said second provider server upon receiving this e-mail,

wherein said second provider server transfers an e-mail that has been transferred from said first provider server to said address change notification deputization service server upon receiving this e-mail, and

wherein said address change notification deputization service server checks the path of the e-mail that has been transferred from said second provider server and makes a notification to the sender of the e-mail to the effect that the e-mail address of said client is said second mail address in the case that this e-mail is received by said second provider server after transfered by said second provider server.

The 2nd invention of the present invention is the e-mail address change notification deputization system according to 1st invention, wherein said address change notification deputization service server is provided with an e-mail header analyzing means of extracting and analyzing the e-mail header from said transferred e-mail, and

wherein said e-mail header analyzing means checks said path by analyzing the e-mail header of said e-mail.

The 3rd invention of the present invention is the e-mail address change notification deputization system according to 1st invention, wherein a terminal of said client receives said e-mail from said second provider server, and

the e-mail received by the terminal of said client has the same contents as of the e-mail transferred to said address change notification deputization service server.

The 4th invention of the present invention is the e-mail address change notification deputization system according to 1st invention, wherein said address change notification deputization service server makes a notification, to said client, of path information whether said e-mail is sent via said first provider server or directly to said second provider server.

The 5th invention of the present invention is the e-mail address change notification deputization system according to 4th invention, wherein said path information includes information as a result of classifying a plurality of said e-mails for the paths and of statistically processing the classified e-mails.

The 6th invention of the present invention is the e-mail address change notification deputization system according to 1st invention, wherein said address change notification deputization service server has e-mail addresses of a predetermined one or a plurality of senders that send an e-mail to said client, and

wherein the operation of making said notification is stopped when all the e-mails sent from the e-mail addresses of said senders have been confirmed to be received by said second provider server without passing through said first provider server.

The 7th invention of the present invention is the e-mail address change notification deputization system according to 1st invention, wherein said address change notification deputization service server simultaneously sends a program for rewriting said first e-mail addresses of said client that is inscribed in an address book of the receivers of said notification to said second mail addresses at the time when carrying out the operation of making said notification.

The 8th invention of the present invention is the e-mail address change notification deputization system according to 1st invention, wherein in the case that a sender of an e-mail to said client is an information distributor, said sender make a contract with the manager of said address change notification deputization service server such that said information distributor spontaneously switches said first e-mail addresses for said client to said second e-mail addresses in the case that said information distributor receives said notification from said address change notification deputization service server.

The 9th invention of the present invention is the e-mail address change notification deputization system according to 8th invention, where in a terminal of said information distributor is provided with a means of switching the addresses of said client to the second e-mail addresses in the case that said notification is received from the manager of said address change notification deputization service server who has made said contract.

The 10th invention of the present invention is an address change notification deputization service server, wherein when a first provider server in which a first mail address of a client is set receives an e-mail that is sent to said first mail address this e-mail is transferred to a second provider server in which a second mail address of said client is set and, then, when said second provider server receives an e-mail transferred from said first provider server said address change notification deputization service server receives this transfer, and

wherein the path of the e-mail transferred from said second provider server is checked and in the case that this e-mail is received by said second provider server after transferred from said first provider server, said address change notification deputization service server makes a notification to the effect that the e-mail address of said client is said second mail address to the sender of this e-mail.

The 11th invention of the present invention is the address change notification deputization service server according to 10th invention, comprising an e-mail header analyzing means of extracting and analyzing an e-mail header from said transferred e-mail,

wherein said e-mail header analyzing means analyzes the e-mail header of said e-mail so as to check said path.

The 12th invention of the present invention is the address change notification deputization service server according to 10th invention, wherein a terminal of said client receives said e-mail from said second provider server, and

wherein the e-mail received by the terminal of said client has the same contents as of the e-mail that is transferred to said address change notification deputization service server.

The 13th invention of the present invention is the address change notification deputization service server according to 10th invention, wherein said client is informed of path information concerning whether said e-mail is sent via said first provider server or is sent directly to said second provider.

The 14th invention of the present invention is the address change notification deputization service server according to 12th invention, wherein said path information includes information resulting from the classification of a plurality of said e-mails according to path and from the statistical processing of said e-mails.

The 15th invention of the present invention is the address change notification deputization service server according to 10th invention, having e-mail addresses of a predetermined sender, or a plurality of sender, that send an e-mail to said client,

wherein the operation of making said notification is stopped when all the e-mails sent from the e-mail addresses of said senders are confirmed to have been received by said second provider server without passing through said first provider server.

The 16th invention of the present invention is the address change notification deputization service server according to 10 th invention, wherein a program for rewriting said first e-mail addresses of said client inscribed in an address book of the receivers of said notification to said second e-mail addresses is simultaneously sent at the time when the operation of making said notification is carried out.

The 17th invention of the present invention is the address change notification deputization service server according to 10th invention, wherein in the case that a sender of an e-mail to said client is an information distributor, a contract is made with said information distributor such that said information distributor spontaneously sets said first e-mail addresses for said client to said second e-mail addresses in the case of receiving said notification from said address change notification deputization service server.

The 18th invention of the present invention is the address change notification deputization service server according to 17th invention, wherein a terminal of said information distributor comprises a means of setting the addresses of said client to the second e-mail addresses in the case that said notification is received from a manager of said address change notification deputization service server who has made said contract.

The 19th invention of the present invention is a second provider server, in which a second mail address of a client is set, for receiving a transfer of an e-mail to said client from a first provider server in which a first e-mail address of said client is set,

wherein said first provider server transfers an e-mail sent to said first e-mail address to said second provider server when receiving this e-mail,

wherein said second provider server transfers an e-mail transferred from said first provider server to an address change notification deputization service server when receiving this e-mail, and

wherein said address change notification deputization service server checks the path of the e-mail transferred from said second provider server and makes a notification to the effect that the e-mail address of said client is said second e-mail address to the sender of said e-mail when this e-mail is received by said second provider server after sent from said first provider server.

The 20th invention of the present invention is a terminal of a client who has made contracts with a first provider server wherein a first e-mail address is set and with a second provider server wherein a second e-mail address is set,

wherein said first provider server transfers an e-mail sent to said first mail address to said second provider server upon receiving this e-mail,

wherein said second provider server transfers an e-mail transferred from said first provider server to an address change notification deputization service server upon receiving this e-mail, and

wherein said address change notification deputization service server checks the path of an e-mail transferred from said second provider server and makes a notification to the effect that the e-mail address of the client is said second e-mail address to the sender of the e-mail in the case that the e-mail is received by said second provider server after transferred from said first provider server.

The 21st invention of the present invention is a terminal of a sender who sends an e-mail to either a first provider server wherein a first e-mail address of a client is set or to a second provider server wherein a second e-mail address of said client is set,

wherein said first provider server transfers an e-mail sent to said first e-mail address to said second provider server upon receiving this e-mail while said second provider server transfers an e-mail sent from said first provider to an address change notification deputization service server upon receiving this e-mail, and

wherein said address change notification deputization service server checks the path of an e-mail transferred from said second provider server and, thereby, the terminal of the sender receives a notification to the effect that the e-mail address of said client is said second e-mail address from said address change notification deputization service server in the case that said e-mail is received by said second provider server after transferred from said first provider.

The 22nd invention of the present invention is an e-mail address change notification deputization method for using a first provider server wherein a first e-mail address of a client is set and a second provider server wherein a second e-mail address of said client is set, comprising:

the step of allowing said first provider server to transfer an e-mail that is sent to said first e-mail address to said second provider server upon receiving this e-mail; and

the step of allowing said second provider server to transfer an e-mail that is transferred from said first provider server to an address change notification deputization service server upon receiving this e-mail,

wherein said address change notification deputization service server checks the path of an e-mail that is transferred from said second provider and makes a notification to the effect that the e-mail address of said client is said second e-mail address to the sender of the e-mail in the case that the e-mail is received by said second provider server after transferred from said first provider server.

The 23rd invention of the present invention is an address change notification deputization service method for receiving a transfer of an e-mail from a second provider server when the second provider server receives the e-mail transferred from a first provider server after the first provider server receives the e-mail that is sent to a first e-mail address and, then, transfers this e-mail to said second provider server, wherein a first e-mail address of a client is set in said first provider server while a second e-mail address of said client is set in said second provider server,

wherein the path of the e-mail transferred from said second provider server is checked and a notification to the sender of the e-mail is made to the effect that the e-mail address of said client is said second e-mail address in the case that the e-mail is received by said second provider server after transferred from said first provider server.

The 24th invention of the present invention is an e-mail reception method, wherein a second provider server in which a second e-mail address of a client is set receives a transfer of an e-mail to said client from a first provider server in which a first e-mail address of the client is set,

wherein said first provider server transfers an e-mail sent to said first e-mail address to said second provider server upon receiving this e-mail,

wherein said second provider server transfers an e-mail transferred from said first provider server to an address change notification deputization service server upon receiving this e-mail, and

wherein said address change notification deputization service server checks the path of an e-mail transferred from said second provider server and makes a notification to the effect that the e-mail address of said client is said second e-mail address to the sender of the e-mail in the case that the e-mail is received by said second provider server after transferred from said first provider server.

The 25th invention of the present invention is an e-mail sending method for sending an e-mail to either a first provider server in which a first e-mail address of a client is set or to a second provider server in which a second e-mail address of said client is set, wherein said first provider server transfers an e-mail, which is sent to said first e-mail address, to said second provider server upon receiving this e-mail and said second provider server transfers an e-mail, which is transferred from said first provider, to an address change notification deputization service server upon receiving this e-mail, and

wherein said address change notification deputization service server checks the path of an e-mail transferred from said second provider server and, thereby, a notification is made by said address change notification deputization service server to the effect that the e-mail address of said client is said second e-mail address in the case that the e-mail is received by said second provider server after transfered from said first provider.

The 26th invention of the present invention is a program for allowing a computer to function as the entirety of, or a part of, the first provider server in which the first e-mail address of the client is set, the second provider server in which the second e-mail address of said client is set and the address change notification deputization service server in the e-mail address change notification deputization system according to 1st invention.

The 27th invention of the present invention is a program for allowing a computer to function as the entirety of, or a part of, the address change notification deputization service server for receiving a transfer of an e-mail when a second provider server receives the e-mail that is transferred from a first provider server after said first provider server receives the e-mail that is sent to a first mail address and, then, transfers this e-mail to said second provider server, wherein the first e-mail address of the client is set in said first provider server while the second e-mail address of said client is set in said second provider server according to 10th invention.

The 28th invention of the present invention is a program for allowing a computer to function as the entirety of, or a part of, the terminal of the sender who sends an e-mail to either the first provider server wherein the first e-mail address of the client is set or to the second provider server wherein the second e-mail address of said client is set according to 21st invention.

The 29th invention of the present invention is a medium that holds a program for allowing a computer to function as the entirety of, or a part of, the first provider server in which the first e-mail address of the client is set, the second provider server in which the second e-mail address of said client is set and the address change notification deputization service server in the e-mail address change notification deputization system according to 1st invention, wherein the medium can be processed by a computer.

The 30th invention of the present invention is a medium that holds a program for allowing a computer to function as the entirety of, or a part of, the address change notification deputization service server for receiving a transfer of an e-mail when a second provider server receives the e-mail that is transferred from a first provider server after said first provider server receives the e-mail that is sent to a first mail address and, then, transfers this e-mail to said second provider server, wherein the first e-mail address of the client is set in said first provider server while the second e-mail address of said client is set in said second provider server according to 10th invention, wherein the medium can be processed by a computer.

The 31st invention of the present invention is a medium that holds a program for allowing a computer to function as the entirety of, or a part of, the terminal of the sender who sends an e-mail to either the first provider server wherein the first e-mail address of the client is set or to the second provider server wherein the second e-mail address of said client is set according to 21st invention, wherein the medium can be processed by a computer.

### BRIEF DESCRIPTION OF THE DRAWINGS

FIG. 1 is a configuration diagram of an e-mail address change notification deputization system according to Embodiment 1 of the present invention;

FIG. 2 is a schematic diagram of an e-mail header that is checked in the e-mail address change notification deputization system according to Embodiment 1 of the present invention;

FIG. 3 is a diagram for describing the operation of an e-mail address change notification deputization system according to Embodiment 2 of the present invention; and

FIG. 4 is a configuration diagram of the e-mail address change notification deputization system according to Embodiment 1 of the present invention.

Description of Symbols

| | |
|---|---|
| 100, 400 | e-mail address change notification deputization |
| | system |
| 110 | address change notification deputization service |
| | provider |
| 120 | client |
| 130 | sender |
| 140 | new provider |
| 150 | old provider |
| 410 | news distribution company |

### PREFERRED EMBODIMENTS OF THE INVENTION

In the following, the embodiments of the present invention are described in reference to the drawings.

(Embodiment 1)

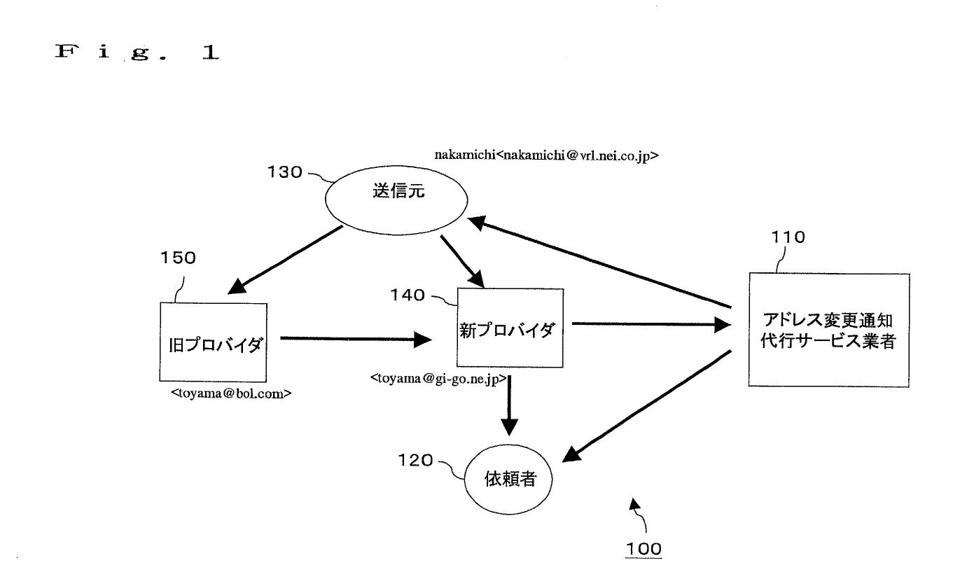

FIG. 1 is a configuration view of an e-mail address change notification deputization system according to Embodiment 1 of the present invention.

As shown in FIG. 1, an e-mail address change notification deputization system 100 is provided on a network such as, for example, the Internet, wherein an address change notification deputization service provider 110 is a body that has an address change notification deputization service server that carries out an address deputization service based on a contract with a client 120, the client 120 is a body that has a terminal of the client of the present invention who changes the provider and makes a contract with the address change notification deputization service provider 110, a sender 130 is a body that has a terminal of the transmitter of the present invention who sends an electronic mail (hereinafter referred to as e-mail) to the client 120, a new provider 140 is a body that has a second provider server of the present invention who serves a new e-mail for address client 120 based on a new contract made with the client 120 and an old provider 150 is a body that has a first provider server of the present invention that had provided an e-mail address the client 120 used previously. Here, though services other than the e-mail service provided by the new provider 140 and the old provider 150 include the setting of a home page, and the like, they do not directly relate to the present invention and the descriptions thereof are omitted. In addition, sending, reception or transfer of e-mails is carried out as an operation of the e-mail server provided, respectively, in the second or the first provider server of the present invention.

The operation of the address change notification deputization system 100 having a configuration as in the above is described and an e-mail address change notification deputization method, an address change notification deputization service method, a sending method of an e-mail and a reception method of an e-mail according to Embodiment 1 of the present invention are also described.

First, the client 120 has made a contract with the old provider 150 so as to have an e-mail address “toyama@bol.com” and newly makes a contract with the new provider 140 so as to have an e-mail address “toyama@gi-go.ne.jp.” In addition, the client 120 has not cancelled the contract with the old provider 150 and has the setting wherein an e-mail that has arrived at “toyama@bol.com” is automatically transferred to the e-mail address “toyama@gi-go.ne.jp” without being downloaded after reception. In addition, the sender 130 has an e-mail address “nakamichi@vrl.nei.co.jp” from which an e-mail can be transmitted to either of the e-mail addresses “toyama@bol.com” or “toyama@gi-go.ne.jp” of the client 120.

Furthermore, e-mail addresses of the client 120 provided by both the new provider 140 and the old provider 150 and the names of the e-mail servers of the respective providers, which process the e-mails of the client are registered with the address change notification deputization service provider 110 in advance.

In the case that the sender 130 sends an e-mail to the new e-mail address “toyama@gi-go.ne.jp” of the client 120 in the above described condition, the transmitted e-mail is stored in the e-mail mailbox for the client 120 upon the reception by the e-mail server of the new provider 140 so that the client 120 downloads this at desired time after the arrival of the e-mail. Furthermore, the new provider 140 transfers the received e-mail to the address change notification deputization service provider 110.

Next, in the case that the sender 130 sends an e-mail to the old e-mail address “toyama@bol.com” of the client 120, the sent e-mail is transferred to the new provider 140 after being received by the e-mail server of the old provider 150.

The new provider 140 stores the transferred e-mail in the e-mail mailbox for the client 120 after receiving this and copies this e-mail so as to transfer the e-mail of the copied content to the address change notification deputization service provider 110.

The address change notification deputization service provider 110 analyzes the header portion of the e-mail when receiving the transfer of the e-mail from the new provider 140.

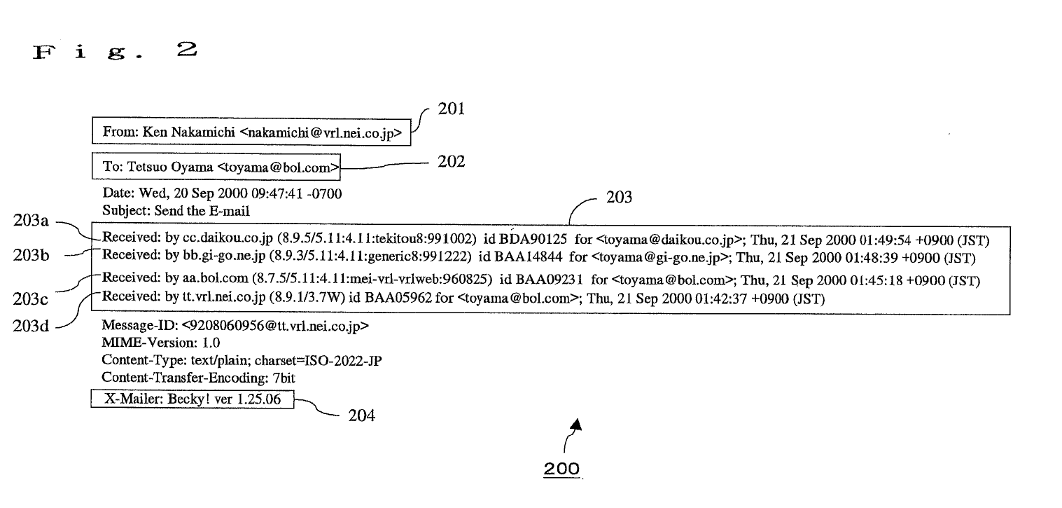

Here, FIG. 2 is a view showing one example of the e-mail header that is the header portion of the e-mail that has arrived at the new provider 140 from the sender 130 through the old provider 150. As shown in the figure, an e-mail header 200 is standardized by RFC822 from among RFC (request for comments) that is a standard collection of TCP/IP, a sender row 201 is a portion that inscribes the e-mail address of the sender 130 of the e-mail and an address row 202 is a portion that inscribes the e-mail address of the client 120 to whom the e-mail is sent.

In addition, a sending path row 203 is a portion that inscribes the e-mail servers through which the e-mail has passed and the uppermost row 203 a inscribes who is the e-mail server that has finally received the e-mail. In the example shown in FIG. 2, the row 203 a shows the e-mail server (cc.daikou.co.jp) of the address change notification deputization service provider 110. The next row 203b inscribes which is the e-mail server that has transferred the e-mail to the e-mail server that has finally received the e-mail. In the example shown in FIG. 2, the row 203b shows the e-mail server (bb.gi-go.ne.jp) of the new provider 140 as the e-mail server that has transferred the e-mail to the e-mail server of the address change notification deputization service provider 110. The next lower row 203c inscribes which is the e-mail server that has transferred the e-mail to the e-mail server inscribed in the row 203b. In the example shown in FIG. 2, the row 203c shows the e-mail server (aa.bol.com) of the old provider 150 as the e-mail server that has transferred the e-mail to thee-mail server of the new provider 140. The lower most row 203d inscribes which is the e-mail server of the sender of the e-mail. In the example shown in FIG. 2, the row 203c shows the e-mail server (tt.vrl.nei.co.jp) of the sender 130.

That is to say, in the sending path rows 203, the uppermost row always inscribes the e-mail server that has finally received the e-mail, the lowermost row always inscribes the e-mail server that has sent the e-mail, while the rows between the uppermost row and the lowermost row always inscribe the e-mail servers that have transferred the e-mail.

The address change notification deputization service provider 110 determines whether or not the mail server is associated with the mail address of the old provider 150 of the client which has already be set by reading out the mail server that is inscribed in a row other than the uppermost row or the lowermost row of the sending path row 203 from the above described mail header 200.

In the case that the mail server that is inscribed in a row other than the uppermost row or the lowermost row of the sending path row 203 is associated with the mail address of the old provider 150, the address change notification deputization service provider 110 prepares an address change notification e-mail for the sender 130 and, then, transmits the e-mail to this sender 130. The contents of this address change notification e-mail maybe contents to the effect that “the e-mail address sent to the client 120 by the sender 130 is not ‘toyama@bol.com’ that is currently set according to the old provider 150 but is ‘toyama@gi-go.ne.jp’ that is set according to the new provider 140 and, therefore, an e-mail sent to the client 120 hereinafter is sent to the address of ‘toyama@gi-go.ne.jp’.”

On the other hand, in the case that the mail server that is inscribed in a row other than the uppermost row or the lowermost row of the sending path row 203 is not associated with the e-mail address of the old provider 150, this e-mail is, for example, directly sent to the new provider 140 from the sender 130 and, therefore, the address change notification deputization service provider 110 does not particularly carry out any processes afterwards on the sender 130.

According to an e-mail address change notification deputization system, an e-mail address change notification deputization method, an address change notification deputization service method, an e-mail sending method and an e-mail reception method according to Embodiment 1 of the present invention in the above manner, in the case that an e-mail has arrived at the client 120 through the new provider 140 from the old provider 150, the address change notification deputization service provider 110 makes a notification that the e-mail address of the client 120 has been changed to the sender 130 of this e-mail and, thereby, it becomes possible for the user of the provider to avoid the inconvenience of making a notification of the changed e-mail address to the parties who have been in correspondence with the user by using the e-mail address of the provider before the change at the same time that the contracted provider is changed.

In addition, as another example of the operation of the present embodiment, the address change notification deputization service provider 110 may send an address book change software patch in the form of an attached file, or the like, in addition to the address change notification e-mail.

This address book change software patch operates in accordance with predetermined e-mail software in the case that an e-mail software description row 204 exists within the e-mail header 200 shown in FIG. 2 and the e-mail software is described therein.

Most of the widely used e-mail software has an address book as a file in the ASCII format formed of predetermined data structures and is managed as a file that has a specific name or a specific extension operator at a specific directory and, therefore, in many cases, it is possible to replace specific data from among data of the above described address book, which is retrieved when the type of the e-mail software is found so that it is also easy to prepare an address book change software patch that carries out the data replacement.

In addition, the address book change software patch may be allowed to have the function of inputting the directory, in which a file that corresponds to the address book exists, as well as the file name to the user of the above described software patch so that the change of the address book is implemented.

When the sender 130 receives the address book change software patch this is implemented and, thereby, it becomes possible to rewrite the address of the client 120 that is registered as an e-mail address of the old provider 150 to an address of the new provider 140 in the address book of the e-mail preparation software that is utilized by the sender 130.

Here, though in the above described embodiment, the address change notification deputization service provider 110 is described as making a notification to the effect that the e-mail address of the client 120 has been changed to the sender 130 by means of an address change notification e-mail, the method of notification is not limited to this but, rather, a means such as mail or telephone may be used as long as a notification of the same contents can be made. In addition, at this time, the address book change software patch may be sent to the sender 130 in a form recorded on a CD-ROM or on a floppy disk.

In addition, the operation by the address change notification deputization service provider 110 of analyzing the e-mail header of the e-mail that has been transferred from the new provider 140 maybe carried out by the e-mail header analyzing means of carrying out an automatic analysis operation of the path of the sent e-mail, which is provided in the e-mail server of the address change notification deputization service provider 110 or a similar operation may be implemented by directly retrieving the header manually by the viewer of the received e-mail on the address change notification deputization service provider 110 side.

(Embodiment 2)

In an e-mail address change notification deputization system according to the present embodiment, an address change notification deputization service provider 110 statistically processes the e-mail transferred from a new provider 140 based on the communication path thereof in addition to the operation described in Embodiment 1 so that the client is informed of the result of the process.

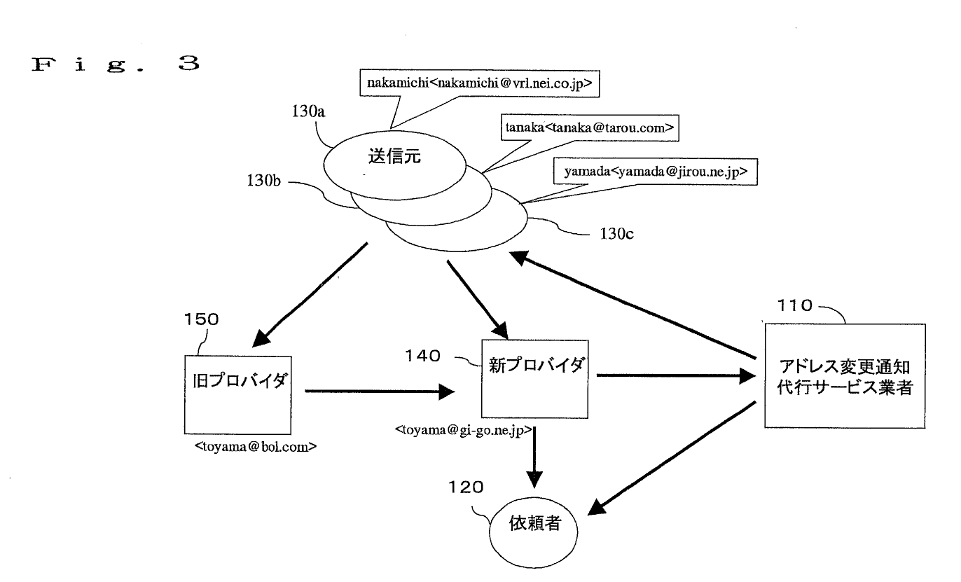

The configuration view of the e-mail address change notification deputization system according to Embodiment 2 of the present invention is the same as of Embodiment 1. In addition, FIG. 3 is a view for describing the e-mail address change notification deputization system according to the present embodiment. The point that differs from the example shown in FIG. 1 is that three senders origins 130a, 130b and 130c exist in place of sender 130. The sender 130a has “nakamichi@vrl.nei.co.jp” as an e-mail address, the sender 130b has “tanaka@tarou.com” as an e-mail address and the sender 130c has “yamada@jirou.ne.jp” as an e-mail address, respectively.

The operation of an address change notification deputization system 100 that has the above described configuration is described and an e-mail address change notification deputization method, an address change notification deputization service method, an e-mail sending method and an e-mail reception method according to Embodiment 2 of the present invention are described. Here, the portions similar to those in Embodiment 1 are omitted and only differing points are described.

First, only the sender 130a “nakamichi” knows the e-mail address of the client 120 of the new provider 140 from among the sender 130 while the other sender 130b “tanaka” and the sender 130c “yamada” believe that the e-mail address of the client 120 is an e-mail address of the old provider 150.

In the above described condition, an e-mail sent from the sender 130a to the client 120 is directly transmitted to the new provider 140 while an e-mail sent from the sender 130b or from the sender 130c is sent to the new provider 140 after being transferred from the old provider 150.

Next, any e-mails sent to the new provider 140 are copied and transferred to the address change notification deputization service provider 110.

The address change notification deputization service provider 110 sends a notification e-mail to the effect that the e-mail address of the client 120 has been changed to the respective e-mail addresses “tanaka@tarou.com” and “yamada@jirou.ne.jp” with respect to the sender 130b and the sender 130c of the e-mails transferred from the old provider 150 from among the e-mails transferred from the new provider 140 in the same manner as in Embodiment 1, while analyzing the e-mail header of each e-mail so as to classify each e-mail sent to the client 120 of all of the above described sender 130 based on the path through which the e-mail has arrived and statistically processes the classification result so as to classify the e-mails that have been so far sent to the client 120 into the e-mails directly sent to the new provider 140 and the e-mails transferred from the old provider 150, which are temporarily stored.

Then, the address change notification deputization service provider 110 sends the stored classification results to the client 120 as an e-mail after a predetermined period of time has passed.

The client 120 receives an e-mail of the classification result from the address change notification deputization service provider 110.

According to this classification result, the client 120 may contact the address change notification deputization service provider 110 so as to stop the e-mail address change notification service or may cancel the contract with the old provider 150. In the case of the above example, since the sender 130b and the sender 130c still send an e-mail to the e-mail address “toyama@bol.com” of the old provider 150, it is not desirable to stop the e-mail address change notification service or to cancel the contract with the old provider 150.

On the other hand, in the case that all of the sender 130a, 130b and 130c are confirmed as having sent an e-mail directly to the new provider 140 according to the classification result e-mailed from the address change notification deputization service provider 110, the client 120 may stop the e-mail address change notification service or may cancel the contract with the old provider 150.

In this manner, the client 120 can determine the timing according to which the e-mail address change notification service of Embodiment 1 is canceled in accordance with the classification result of the path of each e-mail sent from the address change notification deputization service provider 110 to the client 120 according to the present embodiment.

In addition, as another example of the operation of the present embodiment, the client 120 registers in advance e-mail addresses that corresponds to a specific sender 130, with the address change notification deputization service provider 110 as a registration list while, in the case that all the paths of e-mails from the e-mail addresses as senders 130 inscribed in this registration list can be checked to have transmitted from the new provider 140 directly to the client 120, the address change notification deputization service provider 110 may send the client 120 an e-mail to that effect. In addition, the address change notification deputization service provider 110 may spontaneously cancel the e-mail address change notification service for the client 120 or may contact the old provider 150 so as to cancel the contract with the client 120.

Here, though in the above described embodiment, the timing according to which the address change notification deputization service provider 110 e-mails the classification result of the path of each e-mail to the client 120 is described to be according to every predetermined period of time, an e-mail may be sent whenever it becomes necessary in response to a request from the client 120.

In addition, in place of the notification of the classification result by e-mail, other communication means such as mail or telephone may be used.

(Embodiment 3)

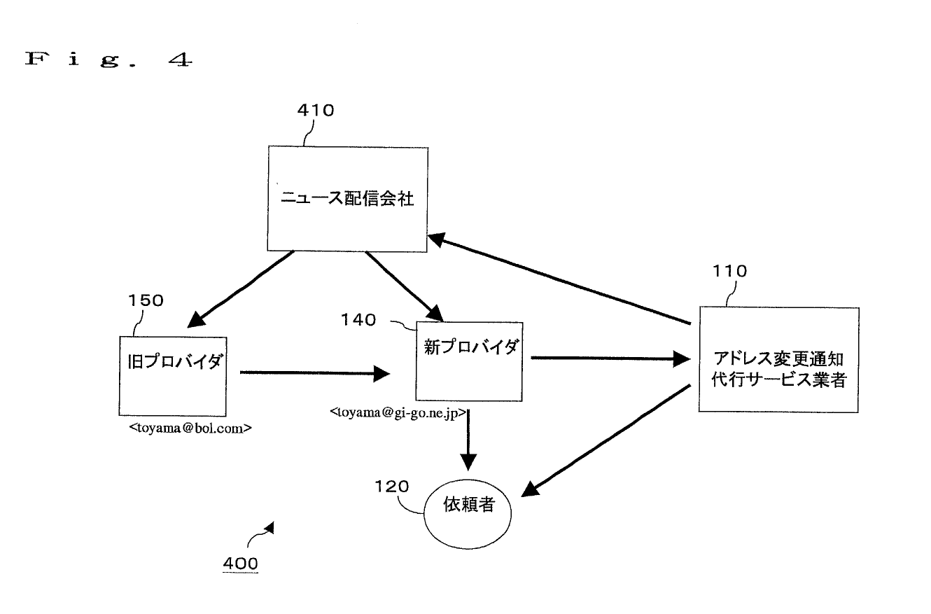

FIG. 4 is a configuration diagram of an e-mail address change notification deputization system according to Embodiment 3 of the present invention.

As shown in FIG. 4, in an e-mail address change notification deputization system 400, the same symbols are attached to the same, or corresponding, parts as in FIG. 1, of which the descriptions are omitted. In addition, a news distribution company 410 is a body that distributes news to a client 120 by means of e-mail according to a contract with a client and that has a terminal of an information distributor of the present invention. Here, in the above described configuration, the news distribution company 410 is an example of the information distributor of the present invention.

The operation of the e-mail address change notification deputization system 400 that has the above described configuration is described and an e-mail address change notification deputization method, an address change notification change notification deputization and an e-mail sending method and an e-mail reception method according to Embodiment 3 of the present invention are described.

First, the client 120 has made a contract with an old provider 150 so as to have an e-mail address “toyama@bol.com” and newly makes a contract with a new provider 140 so that an e-mail address “toyama@gi-go.ne.jp” is provided in the same manner as in the case of Embodiment 1. In addition, the client 120 has not cancelled the contract with the old provider 150 and has the setting wherein an e-mail that has arrived at “toyama@bol.com” is not downloaded upon reception but, rather, is automatically transferred to the e-mail address “toyama@gi-go.ne.jp” of the new provider 140.

Furthermore, the news distribution company 410 distributes news in e-mail format to the e-mail address registered by the client 120 and the settings for e-mail distribution, distribution stop, or the like, are carried out by using a password that is set for every registration. This password is kept secret between the client 120 and the news distribution company 410 and is never leaked to other information sending paths of the e-mail address change notification deputization system 400. In addition, the settings with respect to the input of a password or e-mail distribution are originally carried out by the client 120 accessing the server of the news distribution company 410.

On the other hand, the below described contract is made between the news distribution company 410 and the address change notification deputization service provider 110 so that an operation based on this contract is carried out according to the present embodiment.

In the case that the client 120 does not make a setting to change the receiver of the news distribution by accessing the server of the news distribution company 410 in the above described condition, the news distribution company 410 sends news to the e-mail address “toyama@bol.com” of the old provider 150. The sent news is transferred to the new provider 140 when received by the e-mail server of the old provider 150 in the same manner as in the case of an e-mail of Embodiment 1 so as to be stored in an e-mail mailbox for the client 120 at the new provider 140 and so that the copy thereof is transferred to the address change notification deputization service provider 110.

The address change notification deputization service provider 110 analyses the e-mail header of the news upon reception of the transfer of the news from the new provider 140. When it is confirmed that the news has been distributed to the client 120 via the new provider 140 from the old provider 150, an address change notification e-mail is issued to the news distribution company 410.

The news distribution company 410 switches the e-mail address that is set in the server of the news distribution company 410 as a receiver of news distribution of the client 120 from “toyama@bol.com” of the old provider 150 to the e-mail address “toyama@gi-go.ne.jp” of the new provider 140 upon receiving an address change notification e-mail from the address change notification deputization service provider 110.

The above described operation is based on the above stated contract between the news distribution company 410 and the address change notification deputization service provider 110 and the setting of the e-mail address change for distribution by the news distribution company 410 is carried out regardless of the setting by the client 120. At this time a contract for approving the above described operation has, of course, been made between the client 120 and the address change notification deputization service provider 110 in advance.

As described above in accordance with the e-mail address change notification deputization system according to Embodiment 3 of the present invention, in the case that the client 120 has received a news distribution in an e-mail form from the news distribution company 410 and the e-mail address has been changed due to change of providers, the address change notification deputization service provider 110 checks the news distributed from the old provider 150 via the new provider 140 and makes a notification that the e-mail address of the client 120 has been changed to the news distribution company 410 so that the news distribution company 410 spontaneously switches the destination of the distribution of news based on this notification and, thereby, it becomes possible for the user of the provider to avoid the inconvenience of accessing the news distribution company 410 in order to reset the distribution destination at the time when the contracted provider is changed.

Here, though in the above described embodiment, the news distribution company 410 carries out the change in e-mail address that becomes the distribution destination of the client 120 upon reception of the address change notification e-mail from the address change notification deputization service provider 110, this change may be a manual setting based on the content of the address change notification e-mail or a means of an automatic switching of e-mail addresses by processing the contents of the above address change notification e-mail may be used.

In addition, though in the above described embodiment the news distribution company 410 is described as distributing news in an e-mail form to the client 120, the information distributor of the present invention is not limited to this but, rather, entertainment, advertisements, communication or other information may be distributed as long as information is sent to the client in the form of an e-mail. In addition, the information distributor of the present invention may be implemented as being owned by a company, a corporation or an individual as long as it has a terminal of the information distributor of the present invention that can distribute information to the client in the form of an e-mail.

In addition, though in each of the above described embodiments, the new provider 140 and the address change notification deputization service provider 110 are described as different providers or as different business entities that have different servers, respectively, the new provider 140 may include both the first provider server and the address change notification deputization service server of the present invention so that it also carries out the service provided by the address change notification deputization service provider 110. Thereby, the effects are gained that the new provider 140 can also provide a notification service at the time of e-mail address change to the client 120 who has changed providers from the old provider 150.

In addition, though in each of the above described embodiments the old provider 150 is described as having one provider server, the provider that has the second provider server of the present invention may be singular in number or plural in number. That is to say, in the case that the client transfers a plurality of e-mail addresses that have been respectively set in a plurality of first providers to an e-mail address that is set in the second provider with which a new contract is made, the same effects can be gained in the e-mail address change notification deputization system of the present invention as in the above described embodiments.

In addition, though in the above description for each of the embodiments the e-mail address change notification deputization system, the address change notification deputization service provider, the client and the sender according to the embodiments of the present invention are described, the present invention may be implemented as a program that allows a computer to carry out the functions of the entirety of, or a part of, the means of the above stated e-mail address change notification deputization system, address change notification deputization service provider, second provider server, terminal of the sender or terminal of the client of the present invention, which is a program that operates in cooperation with the computer.

In addition, the present invention may be a medium that holds a program for allowing a computer to carry out the entirety of, or a part of, the functions of the entirety of, or a part of, the means of the above stated e-mail address change notification deputization system, address change notification deputization service server, second provider server, terminal of the sender and terminal of the client of the present invention, which is a medium that is readable by the computer and the above program that is read out carries out the above functions in cooperation with the above computer.

Here, apart of the means of the present invention indicates some means within the plurality of means or steps, or indicates an operation of a portion of the function within one means.

In addition, a part of the units of the present invention means some units within the plurality of units or a part of the means within one unit or it means a portion of the function within one means.

In addition, a recording medium that records a program of the present invention and that is readable by a computer is also included in the present invention.

In addition, one application mode of a program of the present invention may be a mode that is recorded in a recording medium that is readable by a computer and that operates in cooperation with the computer.

In addition, one application mode of a program of the present invention may be a mode that propagates in a transmission medium, that is read out by a computer and that operates in cooperation with the computer.

In addition, the data structure of the present invention includes a data base, a data format, a data table, a data list and other types of data structures.

In addition, the recording medium includes a ROM, or the like, while the transmission medium includes a transmission mechanism such as the Internet, light, radio waves, sound waves, or the like.

In addition, the above described computer of the present invention is not limited to pure hardware such as a CPU but may include firmware, an OS or, additionally, peripheral equipment.

Here, as described above, the structure of the present invention may be implemented in a software manner or may be implemented in a hardware manner.

As is clear from the above description, according to the present invention an e-mail address change notification deputization system, an e-mail address change notification deputization method, and the like, wherein notification to contacts of a change in an e-mail address can be easily carried out at the time when providers are changed are gained.

What is claimed is:

1. An e-mail address change notification deputization system comprising:
a first provider server in which a first e-mail address of a client is set;
a second provider server in which a second e-mail address of said client is set; and
an address change notification deputization service server,
wherein said first provider server transfers an e-mail that is sent to said first mail address to said second provider server upon receiving this e-mail,
wherein said second provider server transfers an e-mail that has been transferred from said first provider server to said address change notification deputization service server upon receiving this e-mail, and
wherein said address change notification deputization service server checks the path of the e-mail that has been transferred from said second provider server and makes a notification to the sender of the e-mail to the effect that the e-mail address of said client is said second mail address in the case that this e-mail is received by said second provider server after transfered by said second provider server.

2. The e-mail address change notification deputization system according to claim 1, wherein said address change notification deputization service server is provided with an e-mail header analyzing means of extracting and analyzing the e-mail header from said transferred e-mail, and
wherein said e-mail header analyzing means checks said path by analyzing the e-mail header of said e-mail.

3. The e-mail address change notification deputization system according to claim 1, wherein a terminal of said client receives said e-mail from said second provider server, and the e-mail received by the terminal of said client has the same contents as of the e-mail transferred to said address change notification deputization service server.

4. The e-mail address change notification deputization system according to claim 1, wherein said address change notification deputization service server makes a notification, to said client, of path information whether said e-mail is sent via said first provider server or directly to said second provider server.

5. The e-mail address change notification deputization system according to claim 4, wherein said path information includes information as a result of classifying a plurality of said e-mails for the paths and of statistically processing the classified e-mails.

6. The e-mail address change notification deputization system according to claim 1, wherein said address change notification deputization service server has e-mail addresses of a predetermined one or a plurality of senders that send an e-mail to said client, and
wherein the operation of making said notification is stopped when all the e-mails sent from the e-mail addresses of said senders have been confirmed to be received by said second provider server without passing through said first provider server.

7. The e-mail address change notification deputization system according to claim 1, wherein said address change notification deputization service server simultaneously sends a program for rewriting said first e-mail addresses of said client that is inscribed in an address book of the receivers of said notification to said second mail addresses at the time when carrying out the operation of making said notification.

8. The e-mail address change notification deputization system according to claim 1, wherein in the case that a sender of an e-mail to said client is an information distributor, said sender make a contract with the manager of said address change notification deputization service server such that said information distributor spontaneously switches said first e-mail addresses for said client to said second e-mail addresses in the case that said information distributor receives said notification from said address change notification deputization service server.

9. The e-mail address change notification deputization system according to claim 8, wherein a terminal of said information distributor is provided with a means of switching the addresses of said client to the second e-mail addresses in the case that said notification is received from the manager of said address change notification deputization service server who has made said contract.

10. An address change notification deputization service server, wherein when a first provider server in which a first mail address of a client is set receives an e-mail that is sent to said first mail address this e-mail is transferred to a second provider server in which a second mail address of said client is set and, then, when said second provider server receives an e-mail transferred from said first provider server said address change notification deputization service server receives this transfer, and
wherein the path of the e-mail transferred from said second provider server is checked and in the case that this e-mail is received by said second provider server after transferred from said first provider server, said address change notification deputization service server makes a notification to the effect that the e-mail address of said client is said second mail address to the sender of this e-mail.

11. The address change notification deputization service server according to claim 10, comprising an e-mail header analyzing means of extracting and analyzing an e-mail header from said transferred e-mail,
wherein said e-mail header analyzing means analyzes the e-mail header of said e-mail so as to check said path.

12. The address change notification deputization service server according to claim 10, wherein a terminal of said client receives said e-mail from said second provider server, and wherein the e-mail received by the terminal of said client has the same contents as of the e-mail that is transferred to said address change notification deputization service server.

13. The address change notification deputization service server according to claim 10, wherein said client is informed of path information concerning whether said e-mail is sent via said first provider server or is sent directly to said second provider.

14. The address change notification deputization service server according to claim 12, wherein said path information includes information resulting from the classification of a plurality of said e-mails according to path and from the statistical processing of said e-mails.

15. The address change notification deputization service server according to claim 10, having e-mail addresses of a predetermined sender, or a plurality of sender, that send an e-mail to said client,
wherein the operation of making said notification is stopped when all the e-mails sent from the e-mail addresses of said senders are confirmed to have been received by said second provider server without passing through said first provider server.

16. The address change notification deputization service server according to claim 10, wherein a program for rewriting said first e-mail addresses of said client inscribed in an address book of the receivers of said notification to said second e-mail addresses is simultaneously sent at the time when the operation of making said notification is carried out.

17. The address change notification deputization service server according to claim 10, wherein in the case that a sender of an e-mail to said client is an information distributor, a contract is made with said information distributor such that said information distributor spontaneously sets said first e-mail addresses for said client to said second e-mail addresses in the case of receiving said notification from said address change notification deputization service server.

18. The address change notification deputization service server according to claim 17, wherein a terminal of said information distributor comprises a means of setting the addresses of said client to the second e-mail addresses in the case that said notification is received from a manager of said address change notification deputization service server who has made said contract.

19. A second provider server, in which a second mail address of a client is set, for receiving a transfer of an e-mail to said client from a first provider server in which a first e-mail address of said client is set,
wherein said first provider server transfers an e-mail sent to said first e-mail address to said second provider server when receiving this e-mail,
wherein said second provider server transfers an e-mail transferred from said first provider server to an address change notification deputization service server when receiving this e-mail, and
wherein said address change notification deputization service server checks the path of the e-mail transferred from said second provider server and makes a notification to the effect that the e-mail address of said client is said second e-mail address to the sender of said e-mail when this e-mail is received by said second provider server after sent from said first provider server.

20. A terminal of a client who has made contracts with a first provider server wherein a first e-mail address is set and with a second provider server wherein a second e-mail address is set,
wherein said first provider server transfers an e-mail sent to said first mail address to said second provider server upon receiving this e-mail,
wherein said second provider server transfers an e-mail transferred from said first provider server to an address change notification deputization service server upon receiving this e-mail, and
wherein said address change notification deputization service server checks the path of an e-mail transferred from said second provider server and makes a notification to the effect that the e-mail address of the client is said second e-mail address to the sender of the e-mail in the case that the e-mail is received by said second provider server after transferred from said first provider server.

21. A terminal of a sender who sends an e-mail to either a first provider server wherein a first e-mail address of a client is set or to a second provider server wherein a second e-mail address of said client is set,
wherein said first provider server transfers an e-mail sent to said first e-mail address to said second provider server upon receiving this e-mail while said second provider server transfers an e-mail sent from said first provider to an address change notification deputization service server upon receiving this e-mail, and
wherein said address change notification deputization service server checks the path of an e-mail transferred from said second provider server and, thereby, the terminal of the sender receives a notification to the effect that the e-mail address of said client is said second e-mail address from said address change notification deputization service server in the case that said e-mail is received by said second provider server after transferred from said first provider.

22. An e-mail address change notification deputization method for using a first provider server wherein a first e-mail address of a client is set and a second provider server wherein a second e-mail address of said client is set, comprising:
the step of allowing said first provider server to transfer an e-mail that is sent to said first e-mail address to said second provider server upon receiving this e-mail; and
the step of allowing said second provider server to transfer an e-mail that is transferred from said first provider server to an address change notification deputization service server upon receiving this e-mail,
wherein said address change notification deputization service server checks the path of an e-mail that is transferred from said second provider and makes a notification to the effect that the e-mail address of said client is said second e-mail address to the sender of the e-mail in the case that the e-mail is received by said second provider server after transferred from said first provider server.

23. An address change notification deputization service method for receiving a transfer of an e-mail from a second provider server when the second provider server receives the e-mail transferred from a first provider server after the first provider server receives the e-mail that is sent to a first e-mail address and, then, transfers this e-mail to said second provider server, wherein a first e-mail address of a client is set in said first provider server while a second e-mail address of said client is set in said second provider server,
wherein the path of the e-mail transferred from said second provider server is checked and a notification to the sender of the e-mail is made to the effect that the e-mail address of said client is said second e-mail address in the case that the e-mail is received by said second provider server after transferred from said first provider server.

24. An e-mail reception method, wherein a second provider server in which a second e-mail address of a client is set receives a transfer of an e-mail to said client from a first provider server in which a first e-mail address of the client is set,
wherein said first provider server transfers an e-mail sent to said first e-mail address to said second provider server upon receiving this e-mail,
wherein said second provider server transfers an e-mail transferred from said first provider server to an address change notification deputization service server upon receiving this e-mail, and
wherein said address change notification deputization service server checks the path of an e-mail transferred from said second provider server and makes a notification to the effect that the e-mail address of said client is said second e-mail address to the sender of the e-mail in the case that the e-mail is received by said second provider server after transferred from said first provider server.

25. An e-mail sending method for sending an e-mail to either a first provider server in which a first e-mail address of a client is set or to a second provider server in which a second e-mail address of said client is set, wherein said first provider server transfers an e-mail, which is sent to said first e-mail address, to said second provider server upon receiving this e-mail and said second provider server transfers an e-mail, which is transferred from said first provider, to an address change notification deputization service server upon receiving this e-mail, and
wherein said address change notification deputization service server checks the path of an e-mail transferred from said second provider server and, thereby, a notification is made by said address change notification deputization service server to the effect that the e-mail address of said client is said second e-mail address in the case that the e-mail is received by said second provider server after transfered from said first provider.

26. A program for allowing a computer to function as the entirety of, or a part of, the first provider server in which the first e-mail address of the client is set, the second provider server in which the second e-mail address of said client is set and the address change notification deputization service server in the e-mail address change notification deputization system according to claim 1.

27. A program for allowing a computer to function as the entirety of, or a part of, the address change notification deputization service server for receiving a transfer of an e-mail when a second provider server receives the e-mail that is transferred from a first provider server after said first provider server receives the e-mail that is sent to a first mail address and, then, transfers this e-mail to said second provider server, wherein the first e-mail address of the client is set in said first provider server while the second e-mail address of said client is set in said second provider server according to claim 10.

28. A program for allowing a computer to function as the entirety of, or a part of, the terminal of the sender who sends an e-mail to either the first provider server wherein the first e-mail address of the client is set or to the second provider server wherein the second e-mail address of said client is set according to claim 21.

29. A medium that holds a program for allowing a computer to function as the entirety of, or a part of, the first provider server in which the first e-mail address of the client is set, the second provider server in which the second e-mail address of said client is set and the address change notification deputization service server in the e-mail address change notification deputization system according to claim 1, wherein the medium can be processed by a computer.

30. A medium that holds a program for allowing a computer to function as the entirety of, or a part of, the address change notification deputization service server for receiving a transfer of an e-mail when a second provider server receives the e-mail that is transferred from a first provider server after said first provider server receives the e-mail that is sent to a first mail address and, then, transfers this e-mail to said second provider server, wherein the first e-mail address of the client is set in said first provider server while the second e-mail address of said client is set in said second provider server according to claim 10, wherein the medium can be processed by a computer.

31. A medium that holds a program for allowing a computer to function as the entirety of, or a part of, the terminal of the sender who sends an e-mail to either the first provider server wherein the first e-mail address of the client is set or to the second provider server wherein the second e-mail address of said client is set according to claim 21, wherein the medium can be processed by a computer.
